(19) United States
(12) Patent Application Publication
(10) Pub. No.: US 2022/0343227 A1
(43) Pub. Date: Oct. 27, 2022

(54) FREIGHT OPTIMIZATION

(71) Applicant: Locomation, Inc., Pittsburgh, PA (US)

(72) Inventor: Thomas R. Kroswek, Novi, MI (US)

(21) Appl. No.: 17/719,526

(22) Filed: Apr. 13, 2022

Related U.S. Application Data
(60) Provisional application No. 63/174,569, filed on Apr. 14, 2021.
(60) Provisional application No. 63/225,112, filed on Jul. 23, 2021.
(60) Provisional application No. 63/305,718, filed on Feb. 2, 2022.

(51) Int. Cl. G06Q 10/04; G06Q 10/08

(52) U.S. Cl. CPC G06Q 10/047; G06Q 10/083

(57) ABSTRACT

Methods for optimizing freight movement via trucks such as semi-trucks. A truckload route is separated into three (3) components: pickup, linehaul and delivery. Assignment of a truck and a driver for each component of the route is treated as a trucking “task” that is separate or independent from other truck-driver combinations assigned to other tasks. Certain terminals (or nodes) are defined where the linehauls start and end and where pickup and delivery components start and end. Local activity is optimized separately from linehaul activity. At the terminals, sufficient area is available to stage trailers or to stage loads that are in transition from one trailer to another.

### CROSS REFERENCE TO RELATED APPLICATIONS

This patent application is related to a co-pending U.S. Provisional Patent Application Ser. No. 63/174,569 entitled “Segmented Relay Transportation Network” filed on Apr. 14, 2021, and U.S. Provisional Application Ser. No. 63/225,112 filed Jul. 23, 2021 entitled “Segmented Relay Transportation Network”, and U.S. Provisional Application Ser. No. 63/305,718 filed Feb. 2, 2022 entitled “Freight Optimization”, the entire contents of each of which are hereby incorporated by reference.

### TECHNICAL FIELD

This application is directed toward optimizing the utilization of trucking equipment and drivers.

### BACKGROUND

Utilization of a truck is typically tied to the utilization of a driver because each is assigned to the other on a one-to-one basis for periods of time longer than a work shift. Some operations go so far as to associate one truck with one driver for very extended periods of time, and they even put the driver's name on the truck.

However, this approach is not ideal because trucks do not need to go off-duty just to rest as humans do. Indeed, the common practice of allowing a driver to sleep in a tractor-trailer combination, or in nearby accommodations, implies that the tractor is unused and the load is not moving toward its destination. When the driver sleeps in the truck, the common practice of idling the engine in order to power the cab's climate control system also contributes significantly to greenhouse gas emissions. Conventional approaches are also prone to requiring a tractor to drive significant distances with no load, known as “empty” miles or “deadheading”.

### SUMMARY

Disclosed herein are systems and methods for optimizing the utilization of trucking equipment and drivers. The solution is to subdivide a truckload route into three (3) components: pickup, linehaul and delivery, and to treat each component as a separate trucking “task” that can be completed by a truck-driver combination that is separate or independent from other truck-driver combinations assigned to other tasks. Pickup and delivery route components are collectively called “local” components herein and the act of moving the associated freight for pickup or delivery is called “local activity”. Also, all pickup components in a local region are managed and optimized separately and collectively, as are linehauls and deliveries.

Furthermore, for each local region with sufficient freight volume, certain terminals (or nodes) are defined where the linehauls start and end and the pickup and delivery components start and end. At terminals, sufficient area is available to stage loads that are in transition from one tractor or trailer to another. The use of terminals reduces empty miles.

Local activity is optimized separately from linehaul activity. When all of the local activity at a terminal is collectively allocated to trucks and scheduled, it becomes possible to optimize numerous performance measures. At a given terminal, for example, a truck-driver combination may alternate between pickups taken to the terminal and deliveries taken from the terminal.

The freight optimization system can attempt to optimize numerous performance measures including: tractor utilization; driver utilization; load transit time; synchronization of drops and picks at origins, destinations, and terminals; distance between drops and picks at origins, destinations, and terminals; fuel usage; idling time; empty miles driven; greenhouse gas emissions; storage volume at terminals; driver hours of service used; or time before return to driver domicile.

Synchronizing local picks and drops can reduce trailer storage at the terminal and reduce transit time.

Matching nearby origins and destinations can reduce the empty miles between a given delivery drop off and the next origin pickup for the same tractor.

Linehaul activity is optimized separately from local activity. At a given terminal, for example, a linehaul driver might drop one load and then pick up another to be taken to another distant terminal, perhaps even the same terminal that the dropped load came from, to be dropped off. Note that this can be drop-hook pairing to eliminate empty miles. If for example, the linehaul schedule is coordinated so that two drivers driving the same route at the same time drop two trailers and pick up two new trailers, then they can be said to be operating a convoy with two trucks.

In addition, linehaul activity may occur along a Segmented Relay Transportation Network (SRTN)

The freight optimization system can attempt to optimize numerous performance measures:

Synchronizing linehaul picks and drops can reduce trailer storage at the terminal and reduce transit time.

Tractor-driver pairs can be allocated to loads that allow the drivers to use up the most possible hours of service without exceeding legal limits.

Tractor-driver pairs can be allocated to loads whose freight routes close a loop so that drivers can return to their domicile on a regular basis.

### BRIEF DESCRIPTION OF THE DRAWINGS

Additional novel features and advantages of the approaches discussed herein are evident from the text that follows and the accompanying drawings, where:

FIGS. 1A and 1B illustrate a routing approach that many truckload carriers operate from in their operations today. The tractor and driver have a 1:1 relationship which implies that the equipment and the driver can only operate 12 hours per day.

FIG. 2 is a representation of a more optimal approach to routing which combines two (2) linehauls and four (4) local moves created by breaking truckload moves into components.

FIGS. 3A to 3D are several example analyses of improved routing approaches and the benefits achieved.

FIG. 4 is a chart illustrating the reduction in layover and rest time with increases in tractor and driver utilization.

FIG. 5 illustrates an example system for assigning drivers, freight, tractors, trailers, and routes according to the SRTN.

FIG. 6 is an example of data entity relationships.

### DETAILED DESCRIPTION OF ILLUSTRATIVE EMBODIMENT(S)

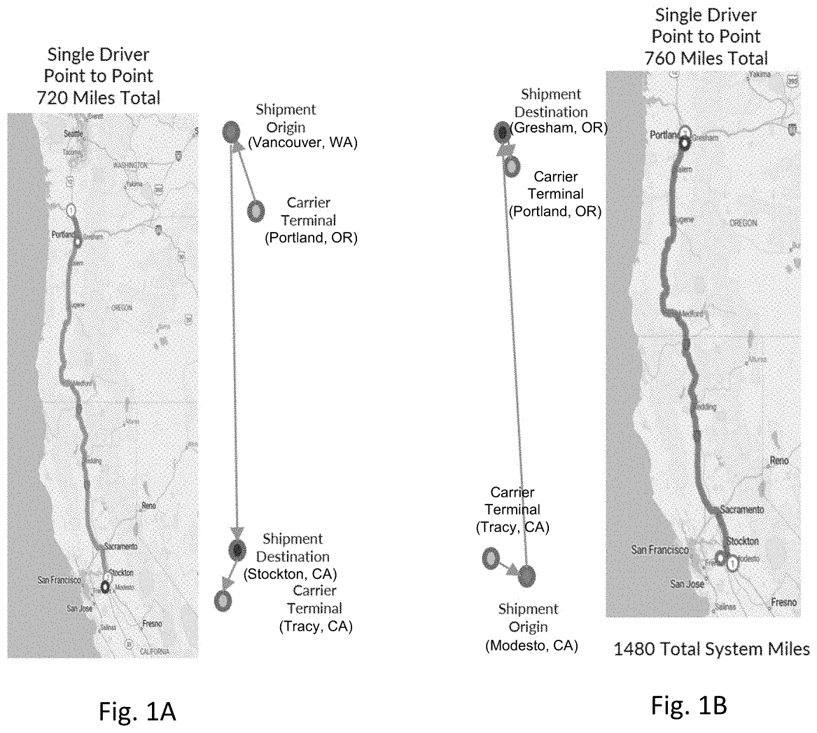

FIG. 1A illustrates a typical approach to routing used today. A driver takes a truck and empty trailer from a carrier terminal (say near Portland, Oreg.) and travels north for a pickup of a load at a shipment origin in Vancouver, Wash. The driver, truck and loaded trailer then drop the load at a shipment destination (in Stockton Calif.) and then the driver drives another empty trailer to a carrier terminal in Tracy, Calif. This trip of some 720+ miles takes a total of 12 or more hours depending on conditions.

As shown in FIG. 1B, the driver may then be assigned a return task, say to leave the carrier terminal in Tracy Calif. with the same (or another) empty trailer, pick up a load at a shipment origin in Modesto, Calif., and head north to a shipment destination in Gresham, Oreg., dropping the load and then returning with an empty trailer to the carrier terminal in Portland, Oreg. The return journey of 760+ miles will again take the single driver approximately 12+ hours total.

For example, the outbound journey of 720 miles of FIG. 1A may take at least 25 hours with 13 hours of driving, 10 hours of rest, and 2 hours for pickup and delivery. The return journey of FIG. 1B may take at least 26 hours including 14 hours of driving, 10 hours rest and 2 hours pickup and delivery. These times can also be extended if there is a delay in coordinating these two loads.

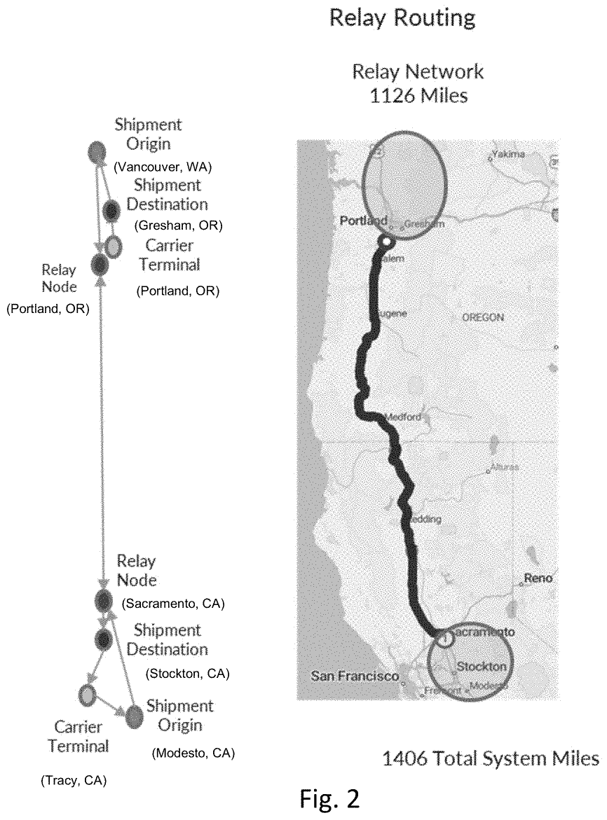

FIG. 2 represents a more optimal approach to handling the same workloads. This approach coordinates two (2) line hauls and four (4) local moves by breaking truckload moves into three components. Here a driver assigned to handle local activity is responsible for bringing the load to the carrier terminal in Portland, Oreg. and then either emptying the load or dropping and unhooking the trailer there. A different driver and truck assigned to linehaul tasks picks up the load (or hooks the trailer) and travels to the carrier terminal in Sacramento, Calif. A third driver assigned to local activity near Sacramento, Calif. then picks up the load and drops it at the destination in Stockton Calif.

The linehaul driver's activity is next coordinated with another load and another task traveling in the opposite direction (say from Sacramento, Calif. to Portland Oreg.) with another driver local to California responsible for moving the freight from the shipment origin in Modesto to the terminal in Sacramento, Calif., and yet another driver local to Oregon responsible for moving the freight from the Portland, Oreg. carrier terminal to Gresham, Oreg.

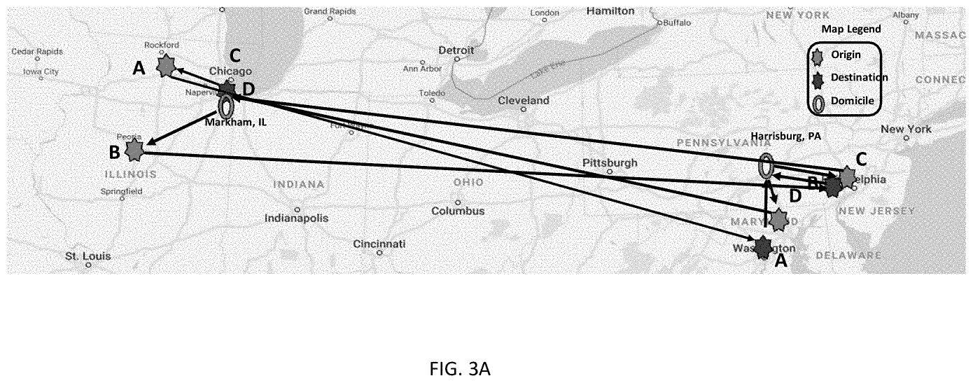

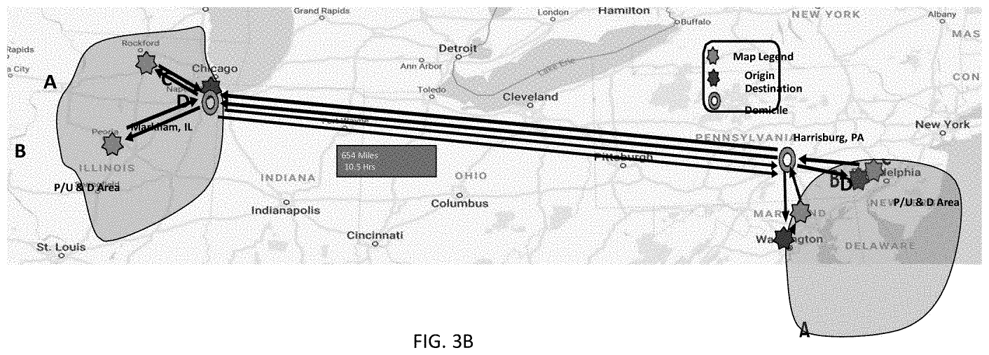

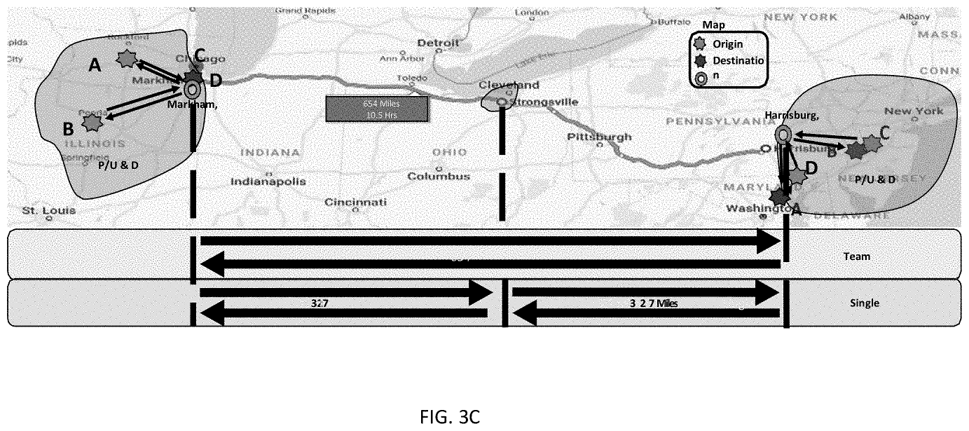

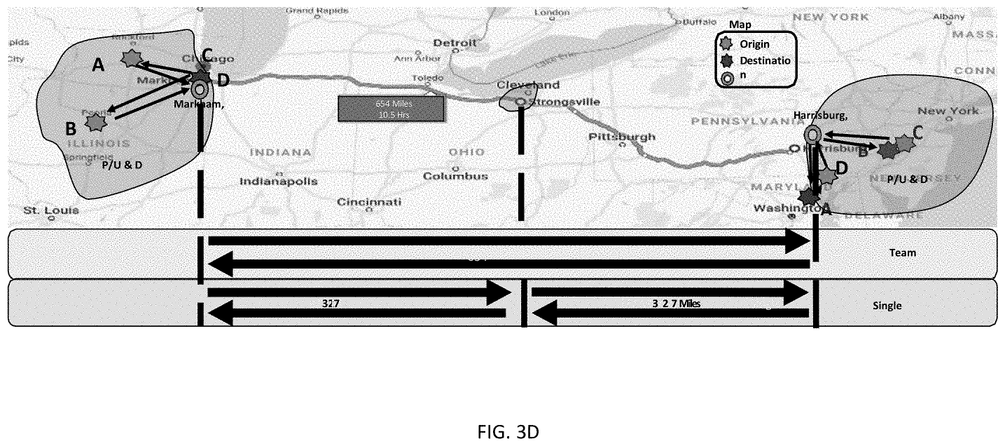

FIG. 3A shows an example of how four loads can be handled. Here each load is assigned to a single “Over the Road” (OTR) driver with drop and hook scenarios with the trailer available and load ready. Drivers originate and terminate in a nearest carrier terminal (referred to in the text on the drawings as “nearest domicile”).

There are two eastbound loads headed from (A) Rockford Ill. to Washington D.C. and (B) Peoria Ill. to Philadelphia Pa. Westbound loads are heading from (C) Philadelphia Pa. to Chicago Ill. and (D) Baltimore Md. to Chicago Ill. The origin of the two eastbound loads are each within 200 miles of a carrier terminal located in Markham, Ill. The westbound loads each have origins within 200 miles of a Harrisburg Pa. carrier terminal.

Load (A) Rockford Ill. to Washington D.C. is a distance of 795 miles, load (B) Peoria Ill. to Philadelphia Pa. a distance of 853 miles, load (C) Philadelphia Pa. to Chicago Ill. a distance of 758 miles and load (D) Baltimore Md. to Chicago Ill. a distance of 702 miles.

Each load is assigned to a single OTR driver, with drop and hook scenarios with trailer available and load ready, originating and terminating in the nearest domicile.

Scheduling is as follows. A first OTR driver is assigned to leave the Markham terminal, and pick up load (A) Rockford->Washington at the Rockford shipment origin and dropping it at the Washington destination. Similarly, another OTR driver is assigned to leave the Markham terminal, and pick up the (B) Peoria->Philadelphia load in Peoria and deliver it to the Philadelphia destination.

For the westbound loads, an OTR driver is assigned to leave the Harrisburg terminal, and pick up the (C) Philadelphia to Chicago load in Philadelphia and deliver it to the Philadelphia destination and an OTR driver is assigned to leave Harrisburg and pick up the (D) Baltimore to Chicago load and deliver it to Chicago.

Planning metrics may include assumed speeds and times for each of the four loads (A through D), including pick up and drop times, pre and post inspection time, layover time, and rest time, the number of loads, number of drivers, total hours to complete, loaded and unloaded miles and resulting tractor and driver utilization. Some example metrics for this particular include
a) Speed 62.5 MPH
b) 0.5 hour for pick up and drop off
c) 0.25 hour for pre- and post-inspection
d) 10 hour layover if over 10.5 hour drive time
e) 0.5 hour rest

Operating metrics for FIG. 3A are as follows:

Each load assigned to a OTR single driver, drop and hook scenarios with trailer available and load ready, originate and terminate in nearest terminal
(Speed is 62.5 MPH, ½ hour for Pick and ½ hour per Drop, ¼ hour for Pre and ¼ hour for Post inspection, 10 hour layover if over 10.5 drive time, ½ hour rest) Operating metrics:
A). Markham, Ill.-Rockford, Ill.-Washington, D.C.-Harrisburg, Pa. (1023 miles)—1 Tractor, 1 Driver, 29 hours to complete, 16.5 Driving, 11 Layover, 1 P&D, ½ Inspection
B). Markham, Ill.-Peoria, Ill.-Philadelphia, Pa.-Harrisburg, Pa. (1109 miles)—1 Tractor, 1 Driver, 30.25 hours to complete, 17.75 Driving, 11 Layover, 1 P&D, ½ Inspection
C). Harrisburg, Pa.-Philadelphia, Pa.-Chicago, Ill.-Markham, Ill. (888 miles)—1 Tractor, 1 Driver, 26.75 hours to complete, 14.25 Driving, 11 Layover, 1 P&D, ½ Inspection
D). Harrisburg, Pa.-Baltimore, Md.-Chicago. Ill.-Markham, Ill. (804 miles)—1 Tractor, 1 Driver, 25.50 hours to complete, 13.00 Driving, 11 Layover, 1 P&D, ½ Inspection Totals: 4 loads, 4 Tractors, 4 Drivers, 111.5 Hours to complete, 61.5 Driving, 44 Layover & Rest, 4 P&D, 2 Inspection, Loaded miles—3108, Total miles—3824

Loaded miles %—81% (Loaded miles/Total miles), Tractor Utilization—59% (Driving Hr.+Insp/Total Hr.), Driver Utilization—63% (Ttl. Hr.−Layover/Ttl. Hr.) FIG. 3B shows how the same four loads can be further optimized using carrier terminals located in Markham, Ill. and Harrisburg, Pa. Here the scheduling takes advantage of splitting each route into three pieces, and coordinating line hauls separately from local activity for both pickup at shipment origin and delivery to shipment destination, and in both directions.

In this example, there are the same workloads—two eastbound loads originating in the Chicago area—(A) from Rockford, Ill. to Washington D.C. and (B) from Peoria, Ill. to Philadelphia Pa. There are also westbound loads headed (C) from Philadelphia to Chicago and (D) from Baltimore to Chicago.

However, ARC segments are utilized and relay points exposed by the following:

Create Pickup and Delivery areas (P/U & D areas)

Coordinate deliveries with pickups within P/U & D Areas,

Create AM and PM P/U & D time windows

Create Relay network(s) between terminals (domiciles)

Drivers and Tractors are assigned to P/U & D or the Relay network

As in the FIG. 3A example, drivers local to Rockford are assigned to pick up the (A) Rockford->Washington load at the Rockford shipment origin and drop it at the Markham terminal, and to pick up the (B) Peoria->Philadelphia load in Peoria and drop it at the Markham terminal. However, in this example, drivers local to Rockford are also assigned to pick up (C) the Philadelphia to Chicago load and deliver it to the Chicago destination and to pick up (D) the Baltimore to Chicago load and deliver it to Chicago.

Two linehaul drivers and trucks are assigned to carry freight eastbound from Markham to Harrisburg. Two linehaul drivers and trucks are assigned to carry freight westbound from Harrisburg to Markham.

In FIG. 3B (as was the case for FIG. 3A), drivers are assigned to pick up the (C) Philadelphia to Chicago load in Philadelphia and deliver it to the Harrisburg terminal and to pick up (D) the Baltimore to Chicago load and deliver from Baltimore to the Harrisburg terminal. However, drivers local to Harrisburg are also assigned to pick up the (A) Rockford->Washington load at the Harrisburg terminal and drop it at the Washington destination, and to pick up the (B) Peoria->Philadelphia load at the Harrisburg terminal and deliver it to the Philadelphia destination.

Operating metrics for FIG. 3B are summarized as follows:

P/U & D assigned to a OTR single driver, drop and hook scenarios with trailer available and load ready, originate and terminate in nearest domicile (Driving time calc by route, ½ hour for Pick and ½ hour per Drop, ¼ hour for Pre and ¼ hour for Post inspection)

Markham Deliver—C P/U—A—1 Tractor, 1 Driver, 5.5 hours to complete, 4 Driving, 1 P&D, ½ Inspection, 215 Miles Total, 127 Loaded, 70% Deliver—D P/U—B—1 Tractor, 1 Driver, 7.0 hours to complete, 5.5 Driving, 1 P&D, ½ Inspection, 340 Miles Total, 174 Loaded, 51%

Harrisburg Deliver—A P/U—D—1 Tractor, 1 Driver, 6.5 hours to complete, 5 Driving, 1 P&D, ½ Inspection, 238 Miles Total, 199 Loaded, 84% Deliver—B P/U—C—1 Tractor, 1 Driver, 5.5 hours to complete, 4 Driving, 1 P&D, ½ Inspection, 225 Miles Total, 215 Loaded, 96%

P/U & D Totals: 4 loads, 2 Tractors, 4 Drivers, 24.5 Hours to complete, 18.5 Driving, 4 P&D, 2 Inspection, 1018 Ttl. Miles, 715 Loaded Miles Loaded miles %—70% (Loaded miles/Total miles), Tractor Utilization—84% (Driving Hr.+Insp/Total Hr.), Driver Utilization—

Relay route assigned to a OTR single driver, drop and hook scenarios with trailer available and load ready, originate and terminate at domicile, 10 Hr. layover at Domicile (Speed 65 MPH, ¼ hour for Pick and ¼ hour per Drop, ¼ hour for Pre and ¼ hour for Post inspection)

Operating metrics: Markham, Ill.-Harrisburg, Pa.—2 Tractors, 2 Drivers, 67 Hours to complete, 42 Driving, 22 Layover & Rest, 2 P&D, 1 Inspection, 2616 Miles Total, 100% Loaded

System Totals: 4 loads, 4 Tractors, 6 Drivers, 91.5 Hours to complete, 60.5 Driving, 21 Layover & Rest, 6 P&D, 3 Inspection, 3616 Ttl. Miles, 3331 Loaded Miles

Loaded miles %—92% (Loaded miles/Total miles), Tractor Utilization—70% (Driving Hr.+Insp/Total Hr.), Driver Utilization—77% (Ttl. Hr.−Layover/Ttl. Hr.)

FIG. 3C is another approach using a Segmented Relay Transportation Network (SRTN) method utilizing additional drivers and an interim or “relay” terminal (in this example, located at Strongsville Ohio) to assist with reducing the total transit time and further improve equipment utilization. The advantage of this approach is that even the line-haul drivers can expect to return to their “home” terminal at the end of each day if desired.

FIG. 3C shows how further optimization is possible for the linehaul portion using the SRTN approach described in more detail below. Briefly, relay routes are assigned to single drivers or driver teams operating the linehaul portion of the route. This approach enables the use of additional drivers to reduce the total transit time and further improve equipment utilization.

Operating metrics for FIG. 3C are summarized as follows:

P/U & D Totals: 4 loads, 2 Tractors, 4 Drivers, 24.5 Hours to complete, 18.5 Driving, 4 P&D, 2 Inspection, 1018 Ttl. Miles, 715 Loaded Miles Loaded miles %—70% (Loaded miles/Total miles), Tractor Utilization—84% (Driving Hr.+Insp/Total Hr.), Driver Utilization—

Relay route assigned to Team drivers or Relay, drop and hook scenarios with trailer available and load ready, originate and terminate at domicile, 10 Hr. layover at Domicile (Speed 65 MPH, ¼ hour for Pick and ¼ hour per Drop, ¼ hour for Pre and ¼ hour for Post inspection) Markham, Ill.-Harrisburg, Pa.—2 Tractors, 4 Drivers, 46 Hours to complete, 42 Driving, 2 Layover & Rest, 2 P&D, 1 Inspection, 2616 Miles Total, 100% Loaded

System Totals: 4 loads, 4 Tractors, 8 Drivers, 71.5 Hours to complete, 60.5 Driving, 2 Layover & Rest, 6 P&D, 3 Inspection, 3616 Ttl. Miles, 3331 Loaded Miles

Loaded miles %—92% (Loaded miles/Total miles), Tractor Utilization—89% (Driving Hr.+Insp/Total Hr.), Driver Utilization—97% (Ttl. Hr.−Layover/Ttl. Hr.)

The operating metrics in FIG. 3D shows improvement across the board using SRTN in total hours to complete, loaded and unloaded miles and tractor and driver utilization.

The operating metrics for the example of FIG. 3D are summarized as follows:

P/U & D Totals: 4 loads, 2 Tractors, 4 Drivers, 24.5 Hours to complete, 18.5 Driving, 4 P&D, 2 Inspection, 1018 Ttl. Miles, 715 Loaded Miles Loaded miles %—70% (Loaded miles/Total miles), Tractor Utilization—84% (Driving Hr.+Insp/Total Hr.), Driver Utilization—

Relay route assigned to Team drivers or Relay, drop and hook scenarios with trailer available and load ready, originate and terminate at domicile (Speed 65 MPH, ¼ hour for Pick and ¼ hour per Drop, ¼ hour for Pre and ¼ hour for Post inspection)

Markham, Ill.-Harrisburg, Pa.—2 Tractors, 2 Drivers, 23.5 Hours to complete, 21 Driving, 1 Layover & Rest, 1 P&D, 0.5 Inspection, 2616 Miles Total, 100% Loaded

System Totals: 4 loads, 4 Tractors, 6 Drivers, 47.5 Hours to complete, 39.5 Driving, 1 Layover & Rest, 5 P&D, 2.5 Inspection, 3616 Ttl. Miles, 3331 Loaded Miles

Loaded miles %—92% (Loaded miles/Total miles), Tractor Utilization—89% (Driving Hr.+Insp/Total Hr.), Driver Utilization—97% (Ttl. Hr.−Layover/Ttl. Hr.)

Further details on how this is achieved are provided below.

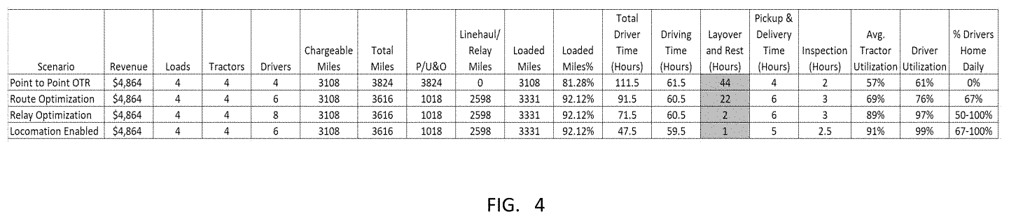

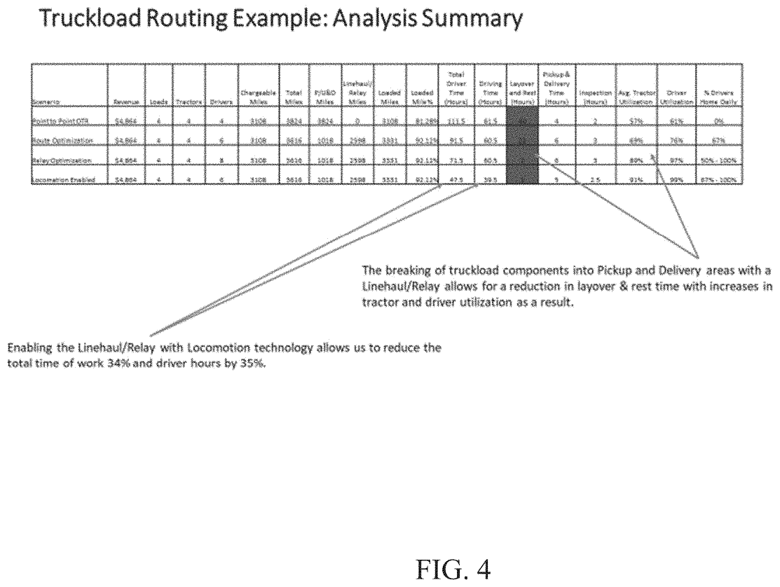

The graphic in FIG. 4 is a summary of the four different scenarios in FIGS. 3A-3D, including total miles, total hours, driver utilization, and how much time drivers can expect to spend at home. The breaking of truckload components into Pickup and Delivery areas with a Linehaul/Relay allows for a reduction in layover & rest time with increases in tractor and driver utilization as a result. Enabling the Linehaul/Relay with Locomotion technology allows us to reduce the total time of work 34% and driver hours by 35%. The latter is an important factor when driver retention is a concern.

Segmented Relay Transportation Network (SRTN)

The above-referenced patent applications describe an SRTN, however an example will also be described here. As shown in FIG. 3D, an example SRTN defines a transportation network comprised of “legs” that initiate and terminate at nodes. Both the legs and the nodes may include locations that already exist on, along or adjacent a highway system. A sequence of connected legs may define a “route” that a vehicle may travel. Intermediate nodes on the route may form junctions at or near highway interchanges between two or more legs. In this example, the SRTN defines legs and nodes across the I-80 interstate highway system with nodes at Markham, Ill., Strongsville, Ohio and Harrisburg, Pa. In this example, the nodes are located approximately 327 miles apart.

A “driver”, as that term is used herein in connection with at least the SRTN, includes either a human or autonomy logic with the added understanding that a driver that ever needs to rest or must comply with Hours of Service (HOS) regulations is a human. An off-duty driver may be located anywhere in a group of two or more vehicles traveling together. Therefore, when a first human is on-duty (“in service”) and driving one vehicle, an autonomy logic may be driving another vehicle, and a second human driver may be off-duty, such that the off-duty driver may sleep in either the human- or the autonomy-driven vehicle.

As shown in FIG. 3D, an important aspect is to arrange the legs and nodes of the SRTN such that it is possible to define or isolate routes between nodes known as “full segments”. Full segments are consistent with (i.e. close to without exceeding) the maximum distance and/or time that a single human driver may drive under prevailing regulations and driving conditions. In the US at this time, a full segment is between roughly 500-700 miles, with its exact value varying depending on local speed limits, and average weather and traffic conditions. In this example, the full segments are 654 miles.

It is also useful to design the SRTN such that it is possible to define or isolate numerous routes that are constrained, as much as possible, to be either fractions or multiples of a full segment as depicted in FIG. 3D. Here there are fractional segments of 327 miles each.

In the example of FIG. 3D, the first two “Team Drivers” rows of arrows depict full segments, and the second two “Single Driver” rows of arrows depict two pairs of fractional segments.

Also, a “double segment” can be defined for longer drives and driven, without stopping for significant periods in the middle, by a team of two drivers that alternately switch from on-duty to off-duty in a mode of operation known as “slip seating”. In this way the off-duty driver can get their mandated rest while the other driver keeps the truck moving. It should be understood that the resting driver may be sleeping or engaged in other activities while the other driver keeps the truck moving. Although not depicted in the figures, a double segment might involve a node located a further distance west from Harrisburg, say in Cozad, Nebr., a total length of 1356 miles.

More generally, a “segment” is any route whose length is an integer multiple of a full segment, or an integer multiple of a fractional segment as defined below. In other words, a segment has a length of (n/m) of a full segment where both n and m are integers and m may not be zero.

If nodes are placed so as to define or isolate numerous routes that are integer fractions of a full segment, known as “fractional segments”, the network then supports efficient “relay operations”. Such nodes are known as “relay nodes”. For example, a single driver could drive a “half segment” in one direction, then swap loads or trailers, and return to the neighborhood of his domicile in a single day of duty. In the example of FIG. 3D, the “relay node” at Strongsville Ohio enables this scenario. By extension, two return trips of a “quarter segment” may be driven in one day of duty, and a return trip of a full segment may be driven by team drivers

More generally, any number of fractional segments may be concatenated into a “composite” route whose total length is a full segment; and some of those composite routes may return, either by traversing in the opposite direction or in a cycle, to the origin of the first load moved.

In these cases of relay operations, by definition, some change to the configuration of the tractor-trailer truck (the “unit”) should occur at a relay node. There can be no value in returning the original load to its origin, but there may be value in swapping drivers in the same unit (as in slip seating), swapping loads (trailers) only, or swapping the entire unit (meaning swapping drivers between units). By doing so, for example, two one-way trips of approximately 500-700 miles in length with two layovers, may become two two-way trips of 250-350 miles in length with all drivers returning home at the end of their duty and no layovers.

Defining the SRTN to Optimally Support Relay Operations

In general, we may define a “configuration” of a tractor-trailer unit to be a time-varying association of a tractor, zero or more trailers, and one or more drivers per tractor, each of whom may be on-duty or off-duty at any moment. It is understood that an on-duty driver must be in the driver's seat of a tractor while off-duty drivers may be anywhere at such times when a change in their duty status is neither imminent nor recent. As a result a configuration change involving driver on-duty status possibly implies movement of drivers into or out of the driver's seat or both. To support relay operations well, the SRTN design should provide numerous, or as many as possible, opportunities to change the configuration of units at relay nodes.

More generally, nodes may be placed, based on the total freight volume on the highway system in a service area (such as a region spanned by all freight movements in the market being addressed), so as to maximize the capacity to decompose all freight movement into segments as defined above.

Configurations Involving Autonomy

In a case where any unit is configured to permit autonomous driving, a driver may rapidly switch from on-duty to off-duty status while remaining in the driver's seat, and this option may be useful to override autonomy or to engage autonomy after a unit has been moved into an appropriate position or other state of motion. In this sense, autonomy is included in the definition of driver. In other words, the “driver” functions discussed herein may be performed either by a human person or by autonomy logic.

Convoys on the SRTN

Another example embodiment exploits the capacity of “split teams” to double equipment utilization or halve the transit time under certain conditions. It is well known that when trucks follow each other in a convoy. Fuel efficiency of both vehicles is therefore enhanced as each benefits from the presence of the other by reducing the wasted power necessary to merely move the air around the vehicles.

If we define a “convoy” to mean any number of units intending to move in formation, then we may, in such a case, redefine a (convoy) “configuration” to be the composite configuration of all participating units as well as a description of the relative positions and the roles of the units, and their status of present, or intended membership. Likewise, we may redefine a (convoy) “configuration change” as any change to the composite configuration of the convoy.

Examples peculiar to convoys may include swapping the role of leader with another vehicle, or the addition or deletion of a vehicle to or from a convoy. When convoys are involved, new relay operations may also be defined including the above convoy configuration changes. Such changes might be used, for example, to reconfigure two convoys arriving at a relay node at roughly the same time when the convoys have arrived or will depart (or both) on distinct legs. The edges connected at such nodes may have a Y topology or a “+” topology or more complicated or general topology.

In one example use of the SRTN, drivers may be assigned to a specific convoy configuration with two drivers assigned to a particular tractor-trailer unit. A schedule for a daily drive may then encompass three fractional segments such that:
a first driver drives during the first fractional segment while the second driver rests;
the second driver drives during the second fractional segment while the first driver rests; and
the first driver or second driver drives during the third fractional segment while the other driver rests.

It should be understood that a driver resting in a unit (e.g., an “off-duty” driver) may actually sleep during the convoy segments when they are assigned to rest while the other driver is active. This may assist with the driver meeting their hours of service rules.

As explained previously, a “driver”, as that term is used herein, may include either a human or autonomy. And as also mentioned previously, an off-duty driver may be anywhere in a convoy.

Therefore, when a first human is “in service” and driving one vehicle, an autonomy is driving another vehicle, and a second driver is off-duty, the off-duty driver may sleep in either the human- or the autonomy-driven tractor.

A duration (or length) of the first and second fractional segment may be approximately equal. The duration (or length) of the third fractional segment may be equal to the amount of driving hours remaining in a given day.

In another use of the SRTN, drivers may be assigned to convoy configurations so that they can return to a domicile at a specified time, such as at the end of each day, or after two days, or after four days, etc. In one example use case, hours of service rules might allow for a total driving time of 11 hours before requiring a 10 hour rest. A single ½ hour break is also required at the 8 hour driving point, so theoretically a driver can drive 10.5 hours before requiring a switch with the other driver. Across a daily schedule this would equate to a first 11 hour segment with driver 1, then another 11 hour segment with driver 2 and then the cycle could start all over with driver 1. There would be two equal fractional segments (remaining out of a 24 hour day) and then a third which would be 2 hours which would be 18% of the other two. As this cycles throughout the week those 2 additional hours of driving rotate between the drivers.

Autonomous Convoys

Furthermore, during periods of time when at least one autonomous driving system is doing the driving of any unit, the convoy thereby becomes a (semi) autonomous or a (fully) autonomous convoy, both of which are referred to as autonomous convoys. Such an autonomous convoy could even include units which are entirely autonomous all of the time.

If we consider an example convoy composed of a human-driven leader and an autonomous follower, then the main benefit of such semi-autonomous operations is that a single human driver may be able to direct the motion of two or more vehicles on the SRTN and:

human driver utilization is thereby doubled because one driver may direct two or more units.

equipment utilization is doubled because drivers in different units may swap being on-duty (and perhaps the units swap positions and roles) to guide the convoy for periods of time.

transit times are improved because the convoy never needs to stop.

all of these benefits increase if there are more autonomous units in the convoy.

all of these benefits increase if the units are autonomous more of the time.

The aforementioned freedom for an off-duty driver to either be sleeping in a human- or the autonomy-driven tractor may require recognition that:

(a) when the two humans are travelling in the same tractor (in-service and off-duty), the convoy will eventually have to stop briefly to swap human drivers (which would be the case for a drone follower configuration); or

(b) when the two humans are not travelling in the same tractor, a human driver that would otherwise sleep in an autonomously operating follower could instead sleep in the human-driven leader (e.g., in a sleeper berth).

Optimal Transportation Management on the SRTN

While transportation management systems are known in industry today, the innovations presented herein lead to both new opportunities to optimize and new related issues to resolve when the invention is practiced.

The SRTN enables new optimization algorithms that exploit its benefits more fully than existing systems. In particular:

every node in the SRTN that is traversed by any two units at roughly the same time presents an opportunity to perform a configuration change.

every node that is traversed in opposite directions by any two trailers at roughly the same time presents an opportunity to convert two one way trips into two way trips.

every one-way leg that is shared by any two units in a given time window presents an opportunity to combine both units in a convoy.

In more general terms, and in contrast to how transportation management is performed today for OTR trucking, a new optimization algorithm, the SRTN Transportation Management Algorithm (STMA) may operate as follows:

Assemble a large number of freight orders that are to be executed in a period of time.

Consider all or a large number of possible configurations of all assets (equipment and drivers) while respecting numerous constraints including HOS constraints.

In the utility function being optimized:

give highest weight to equipment utilization and transit time—keep the tractors moving

give somewhat lower weight to driver utilization—keep the driver on-duty as long a possible and use autonomous operations to reduce the number that are on-duty

give somewhat lower weight to driver at home time—get the drivers home as often and as long as possible.

Other example implementations may vary the weighting of these considerations in arbitrary ways. The term “weight” above may be interpreted to mean an explicit numerical weighting in some function to be optimized. Weight could also be used as a synonym for “priority” if the optimization process treats each of the three considerations above as a hard constraint to be satisfied, if possible, even at the expense of lower priority constraints.

The problem of coordinating the movement of freight is a complex planning and scheduling problem where, among other things, any intended configuration changes require all participating “components” (drivers, tractors, trailers) to be in the same place at roughly the same time.

The task of moving a load in a trailer along a segment can be viewed as a “unit of work” in the STMA. For such a unit of work, at any point in the intended execution of the schedule, a trailer will have made some progress toward its destination in general, and it will have a “next” leg at that point. The next leg will have a start node and an end node.

In contrast to OTR trucking which assigns units to loads, the STMA can assign units of work to configurations whose components are planned to be in the vicinity of the start node of the next leg at close to the same time. The assignment may or may not prefer to simply continue the configuration used to reach the start node. In a case where there is a preference for a return trip for a driver, a configuration change may be performed to permit the driver to return. In a case where units in a convoy have different next legs, a configuration change will be needed for each unit to reach its destination.

In practice, this new management process is similar to treating the tractors on the same leg like continuously operating trains except that the train cars are removed from the train if they are empty. In this analogy, the optimization process is similar to attempting to make sure that the train cars are always full, because they will always be moving in that case.

Optimal Local Transportation Management on the SRTN

A further benefit of the SRTN is the fact that local trucking activity that moves loads between the SRTN nodes and origins, destinations, domiciles, carrier terminals etc. is deliberately removed from the SRTN in the sense that one end or the other of such “local legs” is not an SRTN node. This fact permits the management of local trucking activity to be largely decoupled from the more global activity on the SRTN.

Indeed, local activity can be accomplished with separate, older, lower capacity, lower speed, less automated, etc. equipment that is managed locally with the sole purpose of moving freight to and from the nearest (or nearest few) SRTN nodes with maximum efficiency. In this way the “end nodes” that connect to local legs operate as special relay nodes involving at least one local leg and at least one leg in the SRTN. Such activity may employ surface routes and legs are short enough that the drivers involved may work with more flexible schedules, and near their domiciles, at all times.

Benefits of Freight Optimization

It can now be understood how many benefits such as reducing empty miles, reducing carbon emissions, improving driver and equipment utilization and even permitting drivers to return home at the end of each day are possible. This operating model is feasible to be used with human drivers, autonomous vehicles, and any combination thereof.

These ends are accomplished by disassociating driver utilization from both truck and trailer utilization, specifically by breaking each freight task into three (3) activities—pickup, linehaul, and delivery. Pickup and dropoff activity schedules that are local to a terminal are optimized separately from linehaul activity schedules.

With this approach, a local driver picks up an outbound freight and drops it at a terminal. The same local driver can then pick up inbound freight at the terminal and deliver it locally, and then start the cycle over again. The line haul driver operates independently of the local pickups and deliveries.

It should be understood that implementation of these methods involves a scheduler process operating on one or more computer systems. The scheduler collects freight movement requests, and issues assignments and schedules including location and start and end times for each of the drivers, trucks, and trailers.

For local optimization, finding matching loads may be a matter of minimizing distance traveled. The scheduler knows where the origins and destinations have to be, so it can try to generate sets of pairs of origins and destinations as much as possible, and filter out assignments or pairing that are not optimized in terms of driver usage, empty miles, or down time. More generally, the scheduler should arrange freight and loads so that every optimal configuration that is available for the timeframe planned is taken advantage of. Moves that generate out of route miles, and therefore extra costs, shouldn't be utilized. The scheduler should do a cost versus value calculation and determine if the proposed optimization yields a savings or not and only implement configurations that yield value.

The scheduler should typically optimize activity in this way at each respective terminal to minimize empty miles, even for local drivers. When planning local activity the scheduler should also accommodate both drop and hook loads as well as live load activities, with live unload and load planned separately from drop and hook.

The scheduler may first try to break off pickup, linehaul, and delivery for each task, finding appropriate terminals and attempting to match up multiple tasks with similarly located origins and destinations. For example, the scheduler should try to match two loads moving over the road in different directions at approximately the same time to optimize linehaul by introducing a relay near the middle of the unoptimized route where the drivers swap loads and return to the terminal they left from.

The scheduler may first try to match activity for the entire end to end route, but if that is not possible, it can also try to match with other local-only activity. It will sometimes be the case that 100% of the freight cannot be moved using the “split into three” approach; and in that case, other schedules such as the typical one driver, one truck end to end can be used instead. In addition, if a route or the required delivery time does not lend itself to efficient implementation traveling through the available terminals, then straight end-to-end (as in FIG. 1) can be used.

For example, if a load is to travel from Philadelphia to Scranton in the next 4 hours, the scheduler would not force a route through the Harrisburg terminal unless there was some benefit for it to be a component of some local-line haul-local route configuration. In the absence of such a benefit, a single driver would move the load end-to-end on a route not involving the terminal. Similarly, a load originating in Pittsburgh and headed to Indianapolis, would not necessarily be placed onto the linehaul between the Harrisburg and Marham terminals.

In some implementations, the linehaul activities can be further optimized by using relay points located approximately half-way between terminal nodes.

This approach does require space for storage of trailers and/or freight at the terminal nodes to provide at least some flexibility in scheduling pickups and drops. The greater the space at the terminal nodes, the larger the “queue” and thus the longer the maximum time shipments wait at a terminal to match local to linehaul. In some scenarios, one might start with a small window such as a few hours, and increase or decrease that as the demand for use of the system increases or decreases. The size of the available queue (and storage space) may also be adjusted depending on the rate the customer is willing to pay to move the freight.

Implementation Details

It should be understood that the freight optimization schemes described herein are likely implemented using a number of computing devices and wireless communication devices. Applications software executing on these devices assists with defining the locations of nodes, relay node, segments, and routes, as well as the configurations of tractor-trailer units, changes to unit configurations, coordinating schedules, and providing instructions and schedules to drivers and autonomous vehicles, etc.

As but one example, databases may store and provide access to information related to the current location and availability of resources such as tractors, trailers, drivers, freight to be moved, and the location of nodes and relay nodes, the paths that define segments, and routes, and other information.

One or more servers may operate planning software to devise and assign schedules, relay locations, and routes for the tractors, trailers, drivers and their corresponding assignments to particular jobs. For example, multiple available relay nodes and possible routes and many possible combinations of available tractors, trailers, and drivers can be evaluated to devise a plan to move a particular piece of freight, perhaps using the SRTN.

One or more servers and wired and wireless networks may then make the schedule and route available to other computers and devices. For example, most tractors in use today have onboard computers (OBC's) that can communicate directly with the driver and such systems. These OBCs can be programmed to communicate with the driver and provide updates as to the activity that is to take place within the SRTN. The same can also be accomplished via smartphone apps.

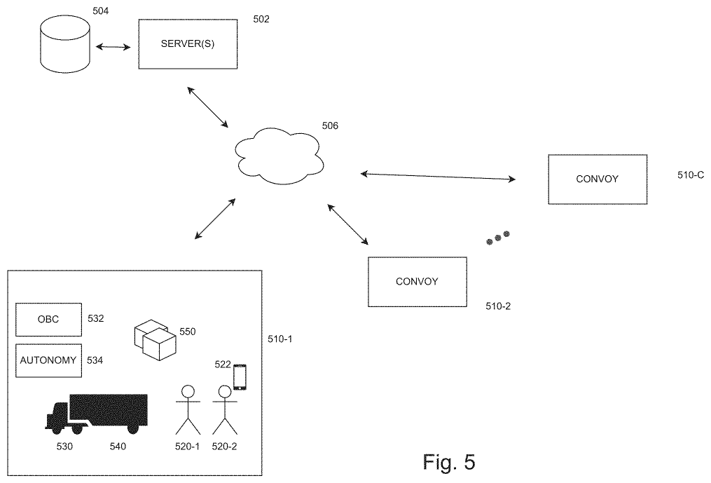

FIG. 5 depicts an example implementation for convoys with the understanding a similar implementation is possible for single units. One or more servers 502 read and write data to a persistent store such as a relational database 504. The server(s) also access data processors associated with one or more convoys 510-1, 510-2, . . . 510-c over a wide area wireless network, which may include the Internet, cellular networks, satellite networks, private wireless networks and numerous other communication schemes. An example convoy 510-1 consists of, say two drivers 520-1, 520-2, a tractor 530, a trailer 540 and freight 550. An On Board Computer (OBC) 532 located on the tractor 530 communicates with the server(s) 502 over the wireless network 506 and displays information to the drivers 520 such as their assigned schedules to particular jobs, awake and sleep times, relay locations, pick up and drop off locations, and routes for their corresponding assignments. Alternatively, the drivers 520 may utilize a smartphone or tablet 522 to receive information and instructions. The tractor 530 also has autonomy logic 534 to implement full or partial self-driving capabilities.

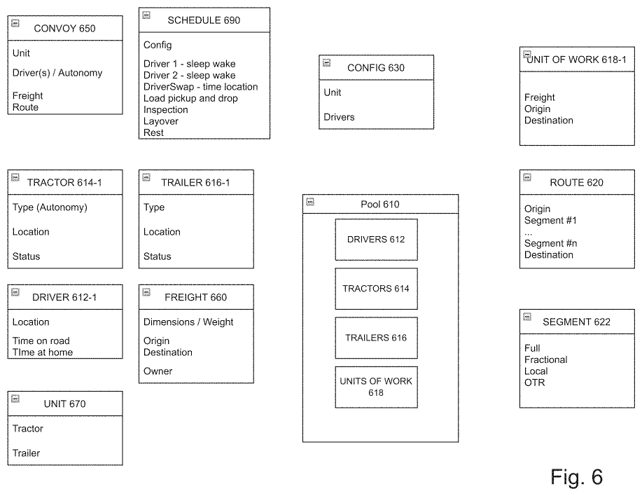

FIG. 6 is but one example of the types of relational data entities that may be maintained in the database 504. Numerous relationships between the data entities as depicted or other data entities not explicitly depicted but mentioned elsewhere herein may also be provided. For example, a driver entity 612-1 includes data about a particular driver, her location, current status (active idle), present and past schedule(s) such as time on the road, time resting, time at home, and the like. A tractor entity 614-1 may include information about its type (model number), whether or not it has autonomy logic, its location and status (active or idle). A trailer entity 616-1 may include information about its type, size, location and status (full load, partial load, or empty). A freight entity 660 describes a freight job, its size, origin, destination owner and other attributes. A unit entity 670 may associate a specific tractor 614 and trailer 616. A config entity may associate a particular unit 670 and team of driver(s) 612. A convoy entity 650 may associate a unit, drivers/autonomy logic, freight and a route. A unit of work entity 618-1 may associate specific freight 660 with an origin and destination. A route entity 620 may include an origin and destination and the legs (segments) that it comprises. A leg (segment) entity 622 may described whether it is full, double, fractional, or an OTR or local segment. A pool entity 610 may list available resources including drivers 612, tractors 614, trailers 616 available to service a particular unit of work 618. A schedule entity 690 may be the result of assigning a configuration, the awake and sleep times for assigned driver(s), and a time and location for the drivers or trailers to swap.

Other possible data elements 690 associated with freight optimization scheduling may include a “trip sheet” composed of a list of loads tobe moved including their origins and destinations and pick up and drop times, or such data as pre and post inspection time, layover time, and rest time, the number of loads, number of drivers, total hours to complete, loaded and unloaded miles.

Implementation Options

The foregoing description of example embodiments illustrates and describes systems and methods for implementing a transportation network. However, it is not intended to be exhaustive or limited to the precise form disclosed.

It should be understood that the example embodiments described above may be implemented in many different ways. In some instances, the various “data processors” may each be implemented by a physical or virtual general purpose computer having a central processor, memory, disk or other mass storage, communication interface(s), input/output (I/O) device(s), and other peripherals. The general-purpose computer is transformed into the processors and executes the processes described above, for example, by loading software instructions into the processor, and then causing execution of the instructions to carry out the functions described.

As is known in the art, such a computer may contain a system bus, where a bus is a set of hardware lines used for data transfer among the components of a computer or processing system. The bus or busses are essentially shared conduit(s) that connect different elements of the computer system (e.g., one or more central processing units, disks, various memories, input/output ports, network ports, etc.) that enables the transfer of information between the elements. One or more central processor units are attached to the system bus and provide for the execution of computer instructions. Also attached to system bus are typically I/O device interfaces for connecting the disks, memories, and various input and output devices. Network interface(s) allow connections to various other devices attached to a network. One or more memories provide volatile and/or non-volatile storage for computer software instructions and data used to implement an embodiment. Disks or other mass storage provides non-volatile storage for computer software instructions and data used to implement, for example, the various procedures described herein.

Embodiments may therefore typically be implemented in hardware, custom designed semiconductor logic, Application Specific Integrated Circuits (ASICs), Field Programmable Gate Arrays (FPGAs), firmware, software, or any combination thereof.

In certain embodiments, the procedures, devices, and processes described herein are a computer program product, including a computer readable medium (e.g., a removable storage medium such as one or more DVD-ROM's, CD-ROM's, diskettes, tapes, etc.) that provides at least a portion of the software instructions for the system. Such a computer program product can be installed by any suitable software installation procedure, as is well known in the art. In another embodiment, at least a portion of the software instructions may also be downloaded over a cable, communication and/or wireless connection.

Embodiments may also be implemented as instructions stored on a non-transient machine-readable medium, which may be read and executed by one or more procedures. A non-transient machine-readable medium may include any mechanism for storing or transmitting information in a form readable by a machine (e.g., a computing device). For example, a non-transient machine-readable medium may include read only memory (ROM); random access memory (RAM); storage including magnetic disk storage media; optical storage media; flash memory devices; and others.

Furthermore, firmware, software, routines, or instructions may be described herein as performing certain actions and/or functions. However, it should be appreciated that such descriptions contained herein are merely for convenience and that such actions in fact result from computing devices, processors, controllers, or other devices executing the firmware, software, routines, instructions, etc.

It also should be understood that the block and system diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and thus the computer systems described herein are intended for purposes of illustration only and not as a limitation of the embodiments.

The above description has particularly shown and described example embodiments. However, it will be understood by those skilled in the art that various changes in form and details may be made therein without departing from the legal scope of this patent as encompassed by the appended claims.

1. A method of optimizing a plurality of shipping tasks, each shipping task associated with moving freight along one or more routes from an origin to a destination, and such that each shipping task is completed by a separate truck-driver combination, the method comprising, for each shipping task:
determining a first terminal location associated with the origin;
determining a second terminal location associated with the destination;
dividing each route into pickup, linehaul, and delivery portions, wherein
the pickup portion comprises a route from the origin to the first terminal;
the delivery portion comprises a route from the second terminal to the destination; and
the linehaul portion comprises a route from the first terminal to the second terminal; and
optimizing assignment of tractors and drivers for the linehaul portion separately from optimizing assignment of tractors and drivers for the pickup and delivery portions.

2. The method of claim 1 wherein the linehaul portion is implemented along a network of nodes, the nodes including
end nodes that serve as locations where a trailer and/or a tractor enter or leave the network; and
relay nodes that serve as locations where a configuration change occurs.

3. The method of claim 2 wherein the network further comprises
a plurality of legs, each leg specifying a unique path between two nodes with no nodes in between the legs optionally constrained to conform to a highway system the legs further organized such that
sequences of legs form full segments that define a route of a length that depends on a maximum daily drive duration in distance or time between two nodes;
fractional segments that define a route having a length that is an integer fraction of a full segment; and
segments that define a route whose length is an integer multiple of a full segment, or an integer multiple of a fractional segment.

4. The method of claim 1 wherein the optimizing further comprises:
optimizing a plurality of pickups and deliveries at each terminal
optimizing a plurality of pickups and deliveries for a given tractor-driver pair
optimizing a plurality of linehauls between pairs of terminals; and/or
optimizing a plurality of linehauls for a given tractor-driver pair.

5. The method of claim 1 wherein the optimizing is determined from one or more of:
tractor utilization;
driver utilization;
load transit time;
synchronization of drops and picks at origins, destinations, and terminals;
distance between drops and picks at origins, destinations, and terminals;
fuel efficiency;
idling time;
empty miles driven;
greenhouse gas emissions;
storage volume at terminals;
driver hours of service used; or
time before return to domicile;
driver at home time.

6. A system for optimizing a plurality of shipping tasks, each shipping task associated with moving freight along one or more routes from an origin to a destination, and such that each shipping task is completed by a separate truck-driver combination, the system comprising:
a computing platform having one or more processors and one or more computer readable memory devices;
program instructions embodied by the one or more computer readable memory devices, the program instructions causing one or more of the processors, when executed, to execute operations including:
determining a first terminal location associated with the origin for a selected shipping task;
determining a second terminal location associated with the destination for the selected shipping task;
dividing a route associated with the selected shipping task into pickup, linehaul, and delivery portions, wherein
the pickup portion comprises a route from the origin to the first terminal;
the delivery portion comprises a route from the second terminal to the destination; and
the linehaul portion comprises a route from the first terminal to the second terminal; and
optimizing assignment of tractors and drivers for the linehaul portion separately from optimizing assignment of tractors and drivers for the pickup and delivery portions.

7. The system of claim 6 wherein the linehaul portion is implemented along a network of nodes, the nodes including
end nodes that serve as locations where a trailer and/or a tractor enter or leave the network; and
relay nodes that serve as locations where a configuration change occurs.

8. The system of claim 7 wherein the network further comprises
a plurality of legs, each leg specifying a unique path between two nodes with no nodes in between the legs optionally constrained to conform to a highway system the legs further organized such that
sequences of legs form full segments that define a route of a length that depends on a maximum daily drive duration in distance or time between two nodes;
fractional segments that define a route having a length that is an integer fraction of a full segment; and
segments that define a route whose length is an integer multiple of a full segment, or an integer multiple of a fractional segment.

9. The system of claim 6 wherein the optimizing further comprises:
optimizing a plurality of pickups and deliveries at each terminal
optimizing a plurality of pickups and deliveries for a given tractor-driver pair
optimizing a plurality of linehauls between pairs of terminals; and/or
optimizing a plurality of linehauls for a given tractor-driver pair.

10. The system of claim 6 wherein the optimizing is determined from one or more of:
tractor utilization;
driver utilization;
load transit time;
synchronization of drops and picks at origins, destinations, and terminals;
distance between drops and picks at origins, destinations, and terminals;
fuel efficiency;
idling time;
empty miles driven;
greenhouse gas emissions;
storage volume at terminals;
driver hours of service used; or
time before return to domicile; or
driver at home time.
